(19) United States
(12) Patent Application Publication
(10) Pub. No.: US 2026/0046384 A1
(43) Pub. Date: Feb. 12, 2026

(54) DISPARITY ADJUSTMENT METHOD FOR EXTENDED REALITY VIDEO, DEVICE, AND STORAGE MEDIUM

(71) Applicant: Beijing Zitiao Network Technology Co., Ltd., Beijing (CN)

(72) Inventors: Chao HU, Beijing (CN); Jianyong CUI, Beijing (CN); Di ZHANG, Beijing (CN); Yuewen MA, Beijing (CN)

(21) Appl. No.: 19/294,480

(22) Filed: Aug. 8, 2025

(30) Foreign Application Priority Data
Aug. 9, 2024 (CN) 202411096216.2

(51) Int. Cl. H04N 13/128; H04N 13/111; H04N 13/178; H04N 13/189

(52) U.S. Cl. CPC H04N 13/128; H04N 13/111; H04N 13/178; H04N 13/189

(57) ABSTRACT

Embodiments of the present application provide a disparity adjustment method, a device, and a storage medium. The method includes: acquiring a depth map of a current frame during a process of recording an extended reality video, wherein the current frame includes a left-eye image and a right-eye image; determining a depth value of the current frame based on the depth map of the current frame; determining disparity adjustment parameters of the current frame based on the depth value of the current frame and a target depth value, wherein the disparity adjustment parameters include a scaling factor and an offset of an image, and the disparity adjustment parameters are used to adjust a disparity of the current frame to a target disparity corresponding to the target depth value; adding the disparity adjustment parameters of the current frame to a video file of the extended reality video.

### CROSS-REFERENCE TO RELATED APPLICATION

This application claims the priority to and benefits of the Chinese Patent Application, No. 202411096216.2, which was filed on Aug. 9, 2024. The aforementioned patent application is hereby incorporated by reference in its entirety.

### TECHNICAL FIELD

Embodiments of the present application relate to a disparity adjustment method for an extended reality video, a device, and a storage medium.

### BACKGROUND

Extended reality (XR) refers to combining the real and the virtual with a computer to create a virtual environment allowing human-computer interaction. XR is also a general term for various technologies such as virtual reality (VR), augmented reality (AR), and mixed reality (MR). By integrating the visual interaction technologies of the three, the experiencer can experience seamless switching between the virtual world and the real world.

A video captured by a binocular camera of an XR device has a disparity. When the disparity is too large, a user may experience visual fatigue when watching the XR video (that is, a 3D video). Therefore, image disparity adjustment needs to be performed on the XR video. In the related art, in a process of recording an XR video, a user manually adjusts a disparity of the video in real time. However, the manual adjustment is cumbersome and the adjustment result is inaccurate.

### SUMMARY

Provided are a disparity adjustment method and apparatus for an extended reality video, a device, and a storage medium. According to the method, automatic adjustment of image disparity can be implemented based on a depth map of an image, so that the problem of cumbersome manual adjustment and inaccurate adjustment can be avoided.

According to a first aspect, an embodiment of the present application provides a disparity adjustment method for an extended reality video. The method includes: acquiring a depth map of a current frame during a process of recording an extended reality video, wherein the current frame includes a left-eye image and a right-eye image; determining a depth value of the current frame based on the depth map of the current frame; determining disparity adjustment parameters of the current frame based on the depth value of the current frame and a target depth value, wherein the disparity adjustment parameters include a scaling factor and an offset of an image, and the disparity adjustment parameters are used to adjust a disparity of the current frame to a target disparity corresponding to the target depth value; and adding the disparity adjustment parameters of the current frame to a video file of the extended reality video.

In some exemplary embodiments, wherein determining the depth value of the current frame based on the depth map of the current frame includes: identifying a shooting subject of the current frame; and calculating an average value of depth values of each pixel point of the shooting subject in the depth map of the current frame to acquire the depth value of the current frame.

In some exemplary embodiments, wherein determining the disparity adjustment parameters of the current frame based on the depth value of the current frame and the target depth value includes: calculating a disparity of the current frame based on the depth value of the current frame; determining disparity adjustment parameters corresponding to the depth value of the current frame based on the depth value of the current frame, the disparity of the current frame, the target depth value, and the target disparity; and determining the disparity adjustment parameters of the current frame based on the disparity adjustment parameters corresponding to the depth value of the current frame.

In some exemplary embodiments, wherein determining the disparity adjustment parameters of the current frame based on the disparity adjustment parameters corresponding to the depth value of the current frame includes: determining the disparity adjustment parameters corresponding to the depth value of the current frame as the disparity adjustment parameters of the current frame.

In some exemplary embodiments, wherein determining the disparity adjustment parameters of the current frame based on the disparity adjustment parameters corresponding to the depth value of the current frame includes: acquiring, based on a preset window length, disparity adjustment parameters in a smoothing window, wherein the smoothing window includes the disparity adjustment parameters corresponding to the depth value of the current frame and disparity adjustment parameters of a plurality of frames before the current frame; and calculating an average value of disparity adjustment parameters of each frame in the smoothing window or a weighted average value of the disparity adjustment parameters of the each frame in the smoothing window to acquire the disparity adjustment parameters of the current frame.

In some exemplary embodiments, wherein determining the disparity adjustment parameters corresponding to the depth value of the current frame based on the depth value of the current frame, the disparity of the current frame, the target depth value, and the target disparity includes: in response to the depth value of the current frame being less than or equal to the target depth value, determining a target depth interval range to which the depth value of the current frame belongs based on the depth value of the current frame and a plurality of depth intervals, wherein different depth intervals correspond to different disparity adjustment parameter determination methods, and the plurality of depth intervals are acquired by division based on the target disparity and the target depth value; determining the disparity adjustment parameters corresponding to the depth value of the current frame based on a disparity adjustment parameters determination method corresponding to the target depth interval range; and in response to the depth value of the current frame being greater than the target depth value, determining that a scaling factor corresponding to the depth value of the current frame is 1 and an offset corresponding to the depth value of the current frame is 0.

In some exemplary embodiments, wherein the plurality of depth intervals are acquired by division as follows: determining that ½ of the target depth value is a first depth value; determining a second depth value based on the target disparity, a minimum value of the scaling factor, and a maximum value of the offset, wherein the second depth value is a minimum depth value that can be adjusted when the image is subjected to disparity adjustment by using the maximum value of the offset and the minimum value of the scaling factor, and the second depth value is less than the first depth value; and dividing an image depth value into three depth intervals based on the first depth value, the second depth value, and the target depth value, wherein a first depth interval is (z1, z_target], a second depth interval is (z2, z1], and a third depth interval is (0, z2], z1 is the first depth value, z2 is the second depth value, and z_target is the target depth value.

In some exemplary embodiments, wherein determining the disparity adjustment parameters corresponding to the depth value of the current frame based on the disparity adjustment parameters determination method corresponding to the target depth interval range includes: in response to the depth value of the current frame being located in the first depth interval, determining that the scaling factor corresponding to the depth value of the current frame is a ratio of the depth value of the current frame to the target depth value, and determining that the offset corresponding to the depth value of the current frame is 0; in response to the depth value of the current frame being located in the second depth interval, determining that the scaling factor corresponding to the depth value of the current frame is the minimum value, and calculating the offset corresponding to the depth value of the current frame based on the disparity of the current frame and the target disparity; and in response to the depth value of the current frame being located in the third depth interval, determining that the scaling factor corresponding to the depth value of the current frame is the minimum value, and determining that the offset corresponding to the depth value of the current frame is the maximum value.

In some exemplary embodiments, wherein determining the second depth value based on the target disparity, the minimum value of the scaling factor, and the maximum value of the offset includes:
calculating the second depth value by using the following formula:

$$z 2 = ( scale\_min * f * b ) / ( shift\_max + d\_target )$$

wherein f is a baseline of a binocular camera, b is a focal length of the binocular camera, d_target is the target disparity, z2 is the second depth value, scale_min is the minimum value of the scaling factor, and shift_max is the maximum value of the offset; and
in response to the depth value of the current frame being located in the second depth interval, calculating the offset corresponding to the depth value of the current frame based on the disparity of the current frame and the target disparity includes: calculating the offset corresponding to the depth value of the current frame by using the following formula:

$$shift = scale\_min * d\_subject - d\_target$$

wherein shift is the offset corresponding to the depth value of the current frame, and d_subject is the disparity of the current frame.

In some exemplary embodiments, wherein calculating the disparity of the current frame based on the depth value of the current frame includes: calculating the disparity of the current frame based on a baseline of a binocular camera, a focal length of the binocular camera, and the depth value of the current frame.

In some exemplary embodiments, further including: determining the target disparity corresponding to the target depth value based on a baseline of the binocular camera, a focal length of the binocular camera, and the target depth value.

In some exemplary embodiments, wherein a frame rate of the disparity adjustment parameters is less than a frame rate of the extended reality video, and the frame rate of the disparity adjustment parameters are equal to a frame rate of the depth map; and before adding the disparity adjustment parameters of the current frame to the video file of the extended reality video, the method further includes: performing linear interpolation on a frame that lacks the disparity adjustment parameters based on the frame rate of the disparity adjustment parameters and the disparity adjustment parameters of the current frame, to acquire disparity adjustment parameters of the frame that lacks the disparity adjustment parameters; and adding the disparity adjustment parameters of the current frame to the video file of the extended reality video includes: adding the disparity adjustment parameters of the current frame and the disparity adjustment parameters of the frame that lacks the disparity adjustment parameters to the video file, respectively.

In some exemplary embodiments, further including: decoding the video file of the extended reality video to acquire texture data of each frame of image in the extended reality video and disparity adjustment parameters of the each frame of the image in the extended reality video; and rendering the texture data of the each frame of the image based on the disparity adjustment parameters of each frame of image acquired by decoding.

In a second aspect, an embodiment of the present application provides a disparity adjustment apparatus for an extended reality video. The apparatus includes: an acquisition module, configured to acquire a depth map of a current frame during a process of recording an extended reality video, wherein the current frame includes a left-eye image and a right-eye image; a disparity adjustment module, configured to determine a depth value of the current frame based on the depth map of the current frame; and the disparity adjustment module is further configured to determine disparity adjustment parameters of the current frame based on the depth value of the current frame and a target depth value, wherein the disparity adjustment parameters includes a scaling factor and an offset of an image, and the disparity adjustment parameters are used to adjust a disparity of the current frame to a target disparity corresponding to the target depth value; and a packaging module, configured to add the disparity adjustment parameters of the current frame to a video file of the extended reality video.

In a third aspect, an embodiment of the present application provides an extended reality, XR, device. The XR device includes a processor and a memory, wherein the memory is configured to store a computer program, and the processor is configured to invoke and run the computer program stored in the memory to perform the method according to any one of the above aspects.

In a fourth aspect, an embodiment of the present application provides a computer-readable storage medium, configured to store a computer program, wherein the computer program, when executed by a computer, causes the computer to perform the method according to any one of the above aspects.

In a fifth aspect, an embodiment of the present application provides a computer program product. The computer program product includes a computer program. When the computer program is executed by a processor, the method according to any one of the above aspects is implemented.

### BRIEF DESCRIPTION OF DRAWINGS

To illustrate the technical solutions in the embodiments of the present invention more clearly, the following briefly introduces the drawings required for describing the embodiments. Apparently, the drawings in the following description show merely some embodiments of the present invention, and a person of ordinary skill in the art may derive other drawings from these drawings without creative efforts.

FIG. 1 is a flowchart of a disparity adjustment method for an extended reality video according to embodiment one of the present application.

FIG. 2 is a flowchart of a recording process of an XR video.

FIG. 3 is a flowchart of a disparity adjustment method for an extended reality video according to embodiment two of the present application.

FIG. 4 is a flowchart of a disparity adjustment method for an extended reality video according to embodiment three of the present application.

FIG. 5 is a schematic diagram of a processing flow of an XR video by an XR player.

FIG. 6 is a schematic diagram of rendering by OpenXR runtime.

FIG. 7 is a flowchart of recording an extended reality video according to embodiment four of the present application.

FIG. 8 is a schematic diagram of functional modules of an XR capture service.

FIG. 9 is a schematic diagram of a structure of a disparity adjustment apparatus for an extended reality video according to embodiment five of the present application.

FIG. 10 is a schematic diagram of a structure of an XR device according to embodiment six of the present application.

### DETAILED DESCRIPTION

The following clearly and comprehensively describes the technical solutions in the embodiments of the present invention with reference to the drawings in the embodiments of the present invention. Apparently, the described embodiments are merely a part rather than all of the embodiments of the present invention. All other embodiments acquired by a person of ordinary skill in the art based on the embodiments of the present invention without creative efforts shall fall within the protection scope of the present invention.

It should be noted that, the terms “first” and “second” in the specification and claims of the present invention and the above drawings are intended to distinguish between similar objects but do not necessarily indicate a specific order or sequence. It should be understood that the data termed in such a way are interchangeable in appropriate circumstances so that the embodiments of the present invention described herein can be implemented in other orders than the order described or illustrated herein. In addition, the term “include” and any variations thereof are intended to cover a non-exclusive inclusion. For example, a process, method, system, product or server that includes a list of steps or units is not necessarily limited to those expressly listed steps or units, but may include other steps or units not expressly listed or inherent to such process, method, product or device.

To facilitate understanding of the embodiments of the present application, some concepts involved in all the embodiments of the present application are first appropriately explained and described before the embodiments of the present application are described. The details are as follows.

The spatial calibration method provided in the embodiments of the present application may be applied to an XR device. The XR device includes, but is not limited to, a VR device, an AR device, and an MR device.

VR: a technology for creating and experiencing a virtual world. A virtual environment is generated by means of calculation, and the virtual environment is multi-source information (the virtual reality mentioned herein at least includes visual perception, and may further include auditory perception, tactile perception, motion perception, and even gustatory perception, olfactory perception, and the like). The virtual environment is used to implement simulation of fused, interactive three-dimensional dynamic scenes and entity behaviors, so that users can be immersed in the simulated virtual reality environment, to implement applications in various virtual environments such as maps, games, videos, education, medical treatment, simulation, collaborative training, sales, assisted manufacturing, maintenance, and repair.

AR: an AR setting refers to a simulated setting in which at least one virtual object is superimposed over a physical setting or a representation of the physical setting. For example, an electronic system may have an opaque display and at least one imaging sensor. The imaging sensor is configured to capture an image or a video of the physical setting, and the image or the video is a representation of the physical setting. The system combines the image or the video with the virtual object, and displays the combination on the opaque display. An individual uses the system to indirectly view the physical setting via the image or the video of the physical setting, and observes the virtual object superimposed over the physical setting. When the system uses one or more image sensors to capture the image of the physical setting and uses those images to present the AR setting on the opaque display, the displayed image is referred to as video transparent transmission. Alternatively, an electronic system for displaying the AR setting may have a transparent or semi-transparent display, and the individual may directly view the physical setting with the display. The system may display the virtual object on the transparent or semi-transparent display, so that the individual uses the system to observe the virtual object superimposed over the physical setting. For another example, the system may include a projection system that projects the virtual object into the physical setting. The virtual object may be projected, for example, on a physical surface or as a hologram, so that the individual uses the system to observe the virtual object superimposed over the physical setting. Specifically, this is a technology in which camera pose parameters of a camera in the real world (or a three-dimensional world or a real world) are calculated in real time in a process of capturing an image by the camera, and virtual elements are added to the image captured by the camera based on the camera pose parameters. The virtual elements include, but are not limited to, an image, a video, and a three-dimensional model. A goal of AR technology is to socket the virtual world on the real world on a screen for interaction.

MR: virtual scene information is presented in a real scene, an interactive feedback information loop is established among the real world, the virtual world, and a user, and the realness of user experience is enhanced. For example, computer-created sensory input (for example, a virtual object) is integrated with sensory input from a physical setting or a representation of the sensory input in a simulated setting. In some MR settings, the computer-created sensory input can be adapted to a change in the sensory input from the physical setting. In addition, some electronic systems for presenting the MR setting can monitor an orientation and/or a position relative to the physical setting, so that the virtual object can interact with a real object (that is, a physical element from the physical setting or a representation of the physical element). For example, the system can monitor a motion, so that a virtual plant looks stationary relative to a physical building.

The virtual reality device refers to a terminal that implements a virtual reality effect, and may usually be provided in the form of glasses, a head-mounted display (abbreviated as HMD), or contact lenses, for implementing visual perception and other forms of perception. Certainly, the implementation form of the virtual reality device is not limited to this, and may be further miniaturized or enlarged according to actual requirements.

Optionally, the virtual reality device (that is, the XR device) described in this embodiment of the present application may include, but is not limited to, the following types.

1) a mobile virtual reality device that supports setting a mobile terminal (such as a smartphone) in various manners (such as a head-mounted display provided with a dedicated card slot). The mobile terminal performs related calculation of a virtual reality function and outputs data to the mobile virtual reality device with a wired or wireless connection with the mobile terminal. For example, a virtual reality video is viewed with an APP of the mobile terminal.

2) an all-in-one virtual reality device that is provided with a processor for performing related calculation of a virtual function, and thus has independent virtual reality input and output functions. The all-in-one virtual reality device does not need to be connected to a PC or a mobile terminal, and has high usage freedom.

3) a PC-end virtual reality (PCVR) device that uses a PC end to perform related calculation of a virtual reality function and data output. An external PC-end virtual reality device uses data output by the PC end to implement a virtual reality effect.

The XR device may use a binocular camera to capture a video. The video captured by the XR device is also referred to as an XR video or a 3D video. The video captured by the XR device has a disparity, that is, a disparity exists between a left-eye image and a right-eye image. When the disparity is too large, it is difficult to synthesize the left-eye image and the right-eye image, resulting in visual fatigue of the user.

Therefore, image disparity adjustment needs to be performed. In the related art, the disparity of each current frame is manually adjusted, and the adjustment efficiency is low and the adjustment result is not ideal. To solve the problems in the related art, an embodiment of the present application provides a disparity adjustment method for an extended reality video, and the disparity of each current frame can be automatically adjusted.

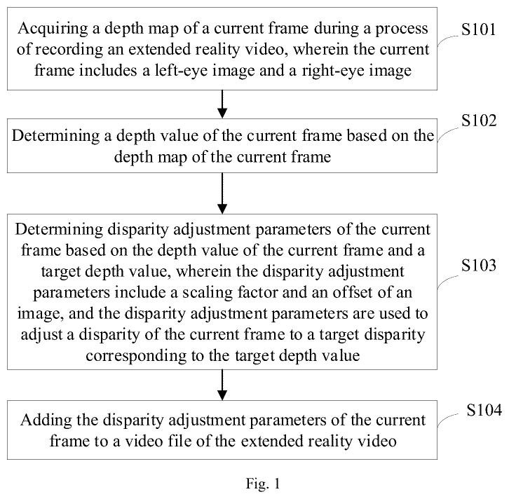

FIG. 1 is a flowchart of a disparity adjustment method for an extended reality video according to embodiment one of the present application. The method is applied to an XR device. As shown in FIG. 1, the method provided in this embodiment includes the following steps.

S101: acquiring a depth map of a current frame during a process of recording an extended reality video, wherein the current frame includes a left-eye image and a right-eye image.

In the XR device, each frame of image is captured by a binocular camera. The binocular camera is also referred to as a binocular RGB (that is, Red Green Blue) camera, and the image captured by the binocular camera is also referred to as an RGB image. In this embodiment, a depth map of the image further needs to be acquired. Each frame of image includes a left-eye image and a right-eye image. The left-eye image and the right-eye image are hereinafter collectively referred to as a left-eye image and a right-eye image.

In this embodiment, a frame rate of the depth map acquired by the XR device may be less than or equal to a video frame rate of the XR video. Exemplarily, the video frame rate is usually 60 frames/sec or 30 frames/sec. When the video frame rate is 60 frames/sec, the frame rate of the depth map may be 60 frames/sec, 30 frames/sec, or 20 frames/sec. When the video frame rate is 30 frames/sec, the frame rate of the depth map may be 30 frames/sec, 15 frames/sec, 10 frames/sec, or the like.

The depth map of the current frame includes depth information of each pixel or each sampled pixel in the current frame. The depth information is also referred to as a depth value, and the depth value of the pixel is used to represent a distance between the pixel and the camera.

Exemplarily, the XR device may acquire the depth map of the image by means of a structured-light apparatus, a binocular camera, a monocular camera, a time-of-flight (TOF) sensor, or the like.

The TOF sensor determines a distance by measuring a flight time of light. Specifically, the TOF sensor continuously emits laser pulses to a measured object, and then receives reflected light by using the sensor. The distance between the camera and the measured object is determined by detecting a round-trip flight time of the light pulses.

S102: determining a depth value of the current frame based on the depth map of the current frame.

The XR device identifies a shooting subject of the current frame, and calculates an average value of depth values of each pixel point of the shooting subject in the depth map of the current frame to acquire the depth value of the shooting subject. The depth value of the shooting subject is the depth value of the current frame.

The XR device may use an existing shooting subject identification algorithm to identify the shooting subject of the current frame. Exemplarily, the identification algorithm may identify a foreground and a background of the current frame, and further identify a foreground object of the current frame to acquire the shooting subject of the current frame. The foreground of the current frame may include a plurality of subjects, and a subject located in the frontmost position may be selected as the shooting subject, or a subject with the largest area may be determined as the shooting subject. The shooting subject may be a person or an object.

After the shooting subject is determined, a pixel region in which the shooting subject is located may be determined in the depth map, and a statistical value of depth values of each pixel point in the pixel region in which the shooting subject is located is determined based on the depth values of the each pixel point in the pixel region in which the shooting subject is located. The statistical value may be an average value of the depth values of the each pixel point in the pixel region in which the shooting subject is located. Optionally, the statistical value may be a median of the depth values of the each pixel point in the pixel region in which the shooting subject is located.

S103: determining disparity adjustment parameters of the current frame based on the depth value of the current frame and a target depth value, wherein the disparity adjustment parameters include a scaling factor and an offset of an image, and the disparity adjustment parameters are used to adjust a disparity of the current frame to a target disparity corresponding to the target depth value.

In the XR device, the closer the binocular camera is to the shooting subject, the greater the disparity of the captured image is, and the farther the binocular camera is from the shooting subject, the smaller the disparity of the captured image is. Based on this, in this embodiment of the present application, a target depth value is set. The target depth value is a target distance between the binocular camera and the shooting subject. When the depth value between the binocular camera and the shooting subject is the target depth value, the disparity of the image captured by the binocular camera is appropriate.

Exemplarily, the target depth value is 0.6 meters (m). It may be understood that in different usage scenarios, the target depth value may have different values.

When the depth value of the current frame is less than or equal to the target depth value, it indicates that the disparity of the current frame is too large. If the disparity of the image is too large, the disparity of the image needs to be reduced. In this embodiment, the disparity of the image may be reduced by reducing a size of the left-eye image and the right-eye image when the video is played and adjusting positions of the left-eye image and the right-eye image in the horizontal direction. To this end, in this embodiment, two disparity adjustment parameters, namely, the scaling factor and the offset of the image, are introduced to adjust the disparity of the image.

The size of the left-eye image and the right-eye image is adjusted by using the scaling factor (scale), and the adjustment based on the scaling factor is also referred to as scale adjustment. The positions of the left-eye image and the right-eye image in the horizontal direction are adjusted by using the offset (shift).

A purpose of disparity adjustment is to adjust the disparity (that is, an actual disparity or a disparity before adjustment) of the image to the target disparity corresponding to the target depth value. In this embodiment, a relationship between the disparity of the image and the depth value of the image may be expressed by using the following formula (1):

$$z = f * b / d \qquad ( 1 )$$

where z represents the depth value of the image, b represents a baseline of the binocular camera (two left and right cameras), f represents a focal length of the camera, and d represents the disparity of the image. The baseline of the two left and right cameras refers to a distance between optical centers of the two left and right cameras. The depth value of the image may be the depth value of the shooting subject of the image, and values of b and f are two fixed values, which are related to camera parameters.

When the target depth value is known, the target disparity may be calculated by using the formula (1). Similarly, when the target disparity is known, the target depth value may also be calculated by using the formula (1). For example, the target disparity may be expressed as the following formula (2):

$$d\_target = f * b / z\_target \qquad ( 2 )$$

The formula (2) is a variation of the formula (1), where d_target represents the target disparity, and z_target represents the target depth value.

Optionally, the target depth value and the target disparity may be pre-calculated based on the formula (1) and input as known parameters of the disparity adjustment method, and there is no need to perform real-time calculation.

In an exemplary manner, the disparity of the current frame is calculated based on the depth value of the current frame. The disparity adjustment parameters corresponding to the depth value of the current frame is determined based on the depth value of the current frame, the disparity of the current frame, the target depth value, and the target disparity. The disparity adjustment parameters of the current frame is determined based on the disparity adjustment parameters corresponding to the depth value of the current frame.

Assuming that the depth value of the image is represented as z_subject, the disparity of the image may be calculated by using the formula (1), and the disparity of the image may be expressed as the following formula (3):

$$d\_subject = f * b / z\_subject \qquad ( 3 )$$

The formula (3) is a variation of the formula (1), and d_subject represents the disparity of the image.

In this embodiment, the disparity adjustment parameters of the current frame may be determined based on the disparity adjustment parameters corresponding to the depth value of the current frame in the following two manners.

In manner 1, the disparity adjustment parameters corresponding to the depth value of the current frame is determined as the disparity adjustment parameters of the current frame.

In manner 2: acquire, based on a preset window length, disparity adjustment parameters in a smoothing window, where the smoothing window includes the disparity adjustment parameters corresponding to the depth value of the current frame and disparity adjustment parameters of a plurality of frames before the current frame; and calculate an average value of disparity adjustment parameters of each frame in the smoothing window or a weighted average value of the disparity adjustment parameters of the each frame in the smoothing window to acquire the disparity adjustment parameters of the current frame.

The disparity adjustment parameters on a frame-by-frame basis may cause inter-frame jitter, resulting in image jitter and affecting the viewing experience of the user. Therefore, the disparity adjustment parameters may be smoothed by using manner 2. The window length of the smoothing window may be any length from 1 to 4 seconds. For example, the window length may be 2 seconds. The window length may alternatively be a fixed number of disparity adjustment parameters. For example, the window length is 30 disparity adjustment parameters or 60 disparity adjustment parameters.

For example, when the window length is 2 seconds, all disparity adjustment parameters within 2 seconds are acquired to form the smoothing window by using the current moment as a start moment. The all disparity adjustment parameters within 2 seconds include the disparity adjustment parameters corresponding to the depth value of the current frame.

For example, when the window length is 60 disparity adjustment parameters, the disparity adjustment parameters corresponding to the depth value of the current frame and disparity adjustment parameters of 59 frames before the current frame are used as the smoothing window.

In this embodiment, the disparity adjustment parameters corresponding to the depth value of the current frame is determined based on the depth value of the current frame, the disparity of the current frame, the target depth value, and the target disparity.

Optionally, the XR device uses formula (4) as a target, and determines the disparity adjustment parameters corresponding to the depth value of the current frame based on a condition that the scaling factor is greater than or equal to the minimum value, the offset is 0 as much as possible, and the offset is less than the maximum value. The formula (4) is as follows:

$$d\_target = d\_subject * scale - shift \qquad ( 4 )$$

where d_target is the target disparity, d_subject is the disparity of the current frame, scale is the scaling factor corresponding to the depth value of the current frame, and shift is the offset corresponding to the depth value of the current frame.

In this embodiment, to avoid excessive image reduction, the minimum value of the scaling factor is set, and the minimum value of the scaling factor is greater than 0 and less than 1. To avoid image synthesis difficulty caused by excessive offset, the maximum value of the offset is set, and the unit of the offset is pixel. Therefore, the value of the scaling factor is greater than or equal to the minimum value and less than or equal to 1, and the value of the offset is greater than or equal to 0 and less than the maximum value.

Exemplarily, the minimum value of the scaling factor is 0.5, and the maximum value of the offset is 30 pixels. Therefore, the value of the scaling factor is greater than or equal to 0.5 and less than or equal to 1, and the value of the offset is greater than or equal to 0 and less than or equal to 30.

In this embodiment, a disparity adjustment policy is as follows: scale adjustment is performed as much as possible, and the offset is 0 as much as possible; when the shooting subject is too close and the disparity of the image cannot be adjusted to the target disparity by scale adjustment, offset adjustment is introduced; or when the shooting subject is closer and neither scale adjustment nor offset adjustment can adjust the disparity of the image to the target disparity, the scaling factor is set to the minimum value, and the offset is set to the maximum value.

It may be understood that in the embodiments of the present application, adjusting the disparity of the image to the target disparity is equivalent to adjusting the depth value of the image to the target depth value.

When the depth value of the current frame is greater than the target depth value, it is determined that the scaling factor of the current frame is 1 and the offset of the current frame is 0. That the scaling factor of the current frame is 1 and the offset of the current frame is 0 may be understood as that the current frame is not scaled or shifted.

When the depth value of the current frame is less than or equal to the target depth value, the scaling factor and the offset are calculated by using a disparity adjustment algorithm based on the depth value of the current frame, where the value of the scaling factor is less than 1 and greater than or equal to the minimum value of the scaling factor, and the offset is greater than or equal to 0 and less than the maximum value of the offset.

S104: adding the disparity adjustment parameters of the current frame to a video file of the extended reality video.

The video file of the XR video may be generated by a MediaMuxer (media wrapper). The video file may be a file in an mp4 format, and may alternatively be a video file in another format.

The media wrapper packages a video stream output by a video encoder, an audio stream acquired after audio data collected by a microphone is encoded, and disparity adjustment parameters of images on a frame-by-frame basis that are output by the disparity adjustment module into the video file in the preset format. The video encoding module is configured to perform video encoding on the image captured by the camera, to acquire the video stream in the preset format. The disparity adjustment module is configured to form the disparity adjustment parameters of each frame of image by using the method provided in this embodiment.

The disparity adjustment parameters of the image may be carried in metadata of the video file. The metadata of the video file includes a file name, a creation date, a file size, video attribute information, audio attribute information, and the like. Exemplarily, the disparity adjustment parameters of the image may be carried in the video attribute information.

According to the disparity adjustment method and apparatus for an extended reality video, the device, and the storage medium provided in the embodiments of the present application, the method includes: in a process of recording the extended reality video, acquiring a depth map of a current frame, and determining a depth value of the current frame based on the depth map of the current frame; determining disparity adjustment parameters of the current frame based on the depth value of the current frame and a target depth value, where the disparity adjustment parameters includes a scaling factor and an offset of an image, and the disparity adjustment parameters are used to adjust a disparity of the current frame to a target disparity corresponding to the target depth value; and adding the disparity adjustment parameters of the current frame to a video file of an XR video. According to the method, the depth value of the image is detected, and the disparity adjustment parameters are determined based on the depth value of the image. The disparity adjustment parameters are carried in the video file on a frame-by-frame basis. In a subsequent playing process, image rendering is performed based on the disparity adjustment parameters in the video file, so that automatic adjustment of image disparity is implemented, and the problem of cumbersome manual adjustment and inaccurate adjustment is avoided.

In this embodiment, a frame rate of the disparity adjustment parameters is less than or equal to a frame rate of the XR video. The frame rate of the disparity adjustment parameters is equal to the frame rate of the depth map. When the frame rate of the disparity adjustment parameters is equal to the frame rate of the XR video, the disparity adjustment parameters are calculated for each frame of image in the XR video by using the disparity adjustment algorithm in this embodiment, and the disparity adjustment parameters of each frame of image in the XR video is added to the video file of the XR video.

When the frame rate of the disparity adjustment parameters is less than the frame rate of the XR video, not every frame of image in the XR video can acquire the disparity adjustment parameters based on the depth map. For example, when the frame rate of the XR video is 60 frames/sec and the frame rate of the disparity adjustment parameters are 15 frames/sec, for a one-second video, the disparity adjustment parameters can be calculated for only 15 frames of images with the depth map, and the remaining 45 frames of images cannot acquire the disparity adjustment parameters by calculation based on the depth map.

In the case where the frame rate of the disparity adjustment parameters is less than the frame rate of the XR video, linear interpolation is performed on the frame that lacks the disparity adjustment parameters based on the frame rate of the disparity adjustment parameters and the disparity adjustment parameters of the current frame, to acquire the disparity adjustment parameters of the frame that lacks the disparity adjustment parameter. The disparity adjustment parameters of the current frame and the disparity adjustment parameters of the frame that lacks the disparity adjustment parameters are added to the video file, respectively.

The XR device may perform linear interpolation on a missing frame between the current frame and a target frame corresponding to the previous disparity adjustment parameter based on the disparity adjustment parameters of the current frame and a previous disparity adjustment parameter after each disparity adjustment parameter is calculated, to acquire disparity adjustment parameters of the missing frame. For example, when the frame rate of the XR video is 60 frames/sec and the frame rate of the disparity adjustment parameters are 15 frames/sec, the disparity adjustment parameters are calculated once every two frames starting from the first frame of image of the XR video, and then the disparity adjustment parameters are interpolated for two missing frames of images.

Optionally, the XR device may alternatively perform interpolation on disparity adjustment parameters of all images that lack disparity adjustment parameters after the XR video image collection ends.

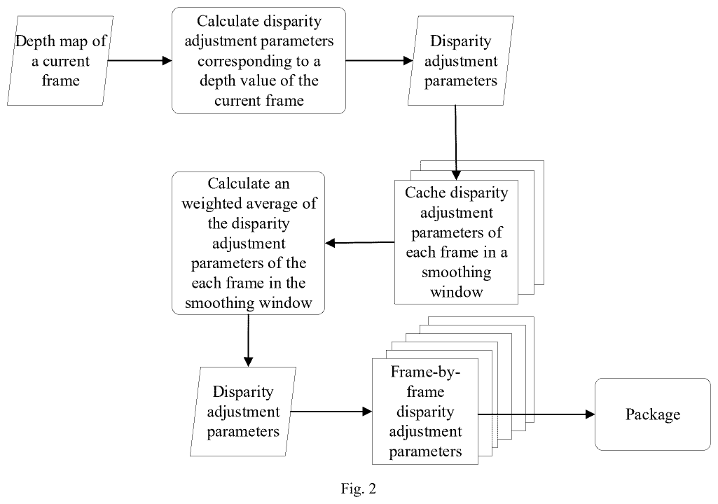

FIG. 2 is a flowchart of a recording process of an XR video. Referring to FIG. 2, a depth map processing module of the XR device transmits the depth map of the current frame to the disparity adjustment module with a Depth API. The disparity adjustment module calculates the disparity adjustment parameters corresponding to the depth value of the current frame based on the depth map of the current frame, caches the disparity adjustment parameters of each frame in the smoothing window, calculates a weighted average value of the disparity adjustment parameters of the each frame in the smoothing window to acquire the disparity adjustment parameters of the current frame, performs linear interpolation to acquire frame-by-frame disparity adjustment parameters, and packages the frame-by-frame disparity adjustment parameters into the video file.

In this embodiment, the depth map of the current frame is acquired in the process of recording the extended reality video, and the depth value of the current frame is determined based on the depth map of the current frame. The disparity adjustment parameters of the current frame are determined based on the depth value of the current frame and the target depth value. The disparity adjustment parameters include the scaling factor and the offset of the image, and the disparity adjustment parameters are used to adjust the disparity of the current frame to the target disparity corresponding to the target depth value. The disparity adjustment parameters of the current frame are added to the video file of the extended reality video. According to the method, the depth value of the image is detected, and the disparity adjustment parameters are determined based on the depth value of the image. The disparity adjustment parameters are carried in the video file on a frame-by-frame basis. In the subsequent playing process, the image rendering is performed based on the disparity adjustment parameters in the video file, so that the automatic adjustment of image disparity is implemented, and the problem of cumbersome manual adjustment and inaccurate adjustment is avoided.

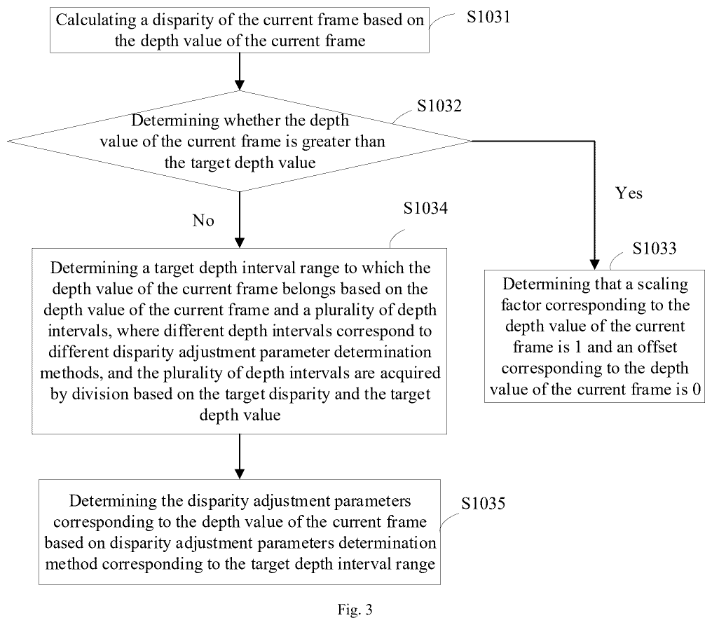

FIG. 3 is a flowchart of a disparity adjustment method for an extended reality video according to embodiment two of the present application. This embodiment mainly details an implementation of step S103 in embodiment one. As shown in FIG. 3, the method in this embodiment includes the following steps.

S1031: calculating a disparity of the current frame based on the depth value of the current frame.

The disparity of the current frame is calculated based on the baseline of the binocular camera, the focal length of the binocular camera, and the depth value of the current frame. For details, refer to the foregoing formula (2).

S1032: determining whether the depth value of the current frame is greater than the target depth value.

When the depth value of the current frame is greater than the target depth value, step S1033 is performed. When the depth value of the current frame is not greater than (that is, less than or equal to) the target depth value, step S1034 is performed.

S1033: determining that a scaling factor corresponding to the depth value of the current frame is 1 and an offset corresponding to the depth value of the current frame is 0.

S1034: determining a target depth interval range to which the depth value of the current frame belongs based on the depth value of the current frame and a plurality of depth intervals, where different depth intervals correspond to different disparity adjustment parameter determination methods, and the plurality of depth intervals are acquired by division based on the target disparity and the target depth value.

Exemplarily, the image depth value is divided into the plurality of depth intervals based on the target disparity and the target depth value as follows:
determining that ½ of the target depth value is a first depth value; determining a second depth value based on the target disparity, the minimum value of the scaling factor, and the maximum value of the offset, where the second depth value is a minimum depth value that can be adjusted when the image is subjected to disparity adjustment by using the maximum value of the offset and the minimum value of the scaling factor, and the second depth value is less than the first depth value; and dividing the image depth value into three depth intervals based on the first depth value, the second depth value, and the target depth value.

The image depth value is divided into the three depth intervals based on the first depth value, the second depth value, and the target depth value, where a first depth interval is (z1, z_target], a second depth interval is (z2, z1], and a third depth interval is (0, z2], z1 is the first depth value, z2 is the second depth value, and z_target is the target depth value.

Exemplarily, the second depth value is calculated by using the following formula (5):

$$z 2 = ( scale\_min * f * b ) / ( shift\_max + d\_target ) \qquad ( 5 )$$

where f is a baseline of a binocular camera, b is a focal length of the binocular camera, d_target is the target disparity, z2 is the second depth value, scale_min is the minimum value of the scaling factor, and shift_max is the maximum value of the offset.

S1035: determining the disparity adjustment parameters corresponding to the depth value of the current frame based on disparity adjustment parameters determination method corresponding to the target depth interval range.

When the depth value of the current frame is located in the first depth interval, it is determined that the scaling factor corresponding to the depth value of the current frame is the ratio of the depth value of the current frame to the target depth value, and the offset corresponding to the depth value of the current frame is determined to be 0.

When the depth value of the current frame is located in the second depth interval, it is determined that the scaling factor corresponding to the depth value of the current frame is the minimum value, and the offset corresponding to the depth value of the current frame is calculated based on the disparity of the current frame and the target disparity.

When the depth value of the current frame is located in the third depth interval, it is determined that the scaling factor corresponding to the depth value of the current frame is the minimum value, and the offset corresponding to the depth value of the current frame is determined to be the maximum value.

When the depth value of the current frame is located in the second depth interval, the offset corresponding to the depth value of the current frame may be calculated by using the following formula (6):

$$shift = scale\_min * d\_subject - d\_target \qquad ( 6 )$$

where shift is the offset corresponding to the depth value of the current frame, and d_subject is the disparity of the current frame, d_target is the target disparity, and scale_min is the minimum value of the scaling factor.

The offset corresponding to the depth value of the current frame is denoted as shift, the scaling factor corresponding to the depth value of the current frame is denoted as scale, the disparity of the current frame is denoted as d_target, the depth value of the current frame is denoted as z_subject, the target depth value is denoted as z_target, the target disparity is denoted as d_target, the minimum value of the scaling factor is denoted as scale_min, and the maximum value of the offset is denoted as shift_max. Therefore, the method for determining the disparity adjustment parameters corresponding to the depth value of the current frame provided in this embodiment may be summarized as follows:

$$scale = 1. shift = 0 when z\_subject > z\_target$$

$$scale = \frac{z\_subject}{z\_target} shift = 0 when \frac{z\_target}{2} < z\_subject \leq z\_target$$

$$scale = scale\_min = scale\_min * d\_subject - d\_target$$

$$when z\_target < z\_subject \leq \frac{z\_target}{2}$$

$$scale = scale\_min = shift\_max when z\_subject \leq z 2$$

$$where z 2 = ( scale\_min * f * b ) / ( shift\_max + d\_target ) .$$

According to the method in this embodiment, the disparity adjustment parameters corresponding to the depth value of the image is calculated in intervals, and different depth intervals correspond to different disparity adjustment parameter determination methods. Therefore, the appropriate disparity adjustment parameters can be determined for the image based on the depth value of the image, so that the calculated disparity adjustment parameters of the image are more accurate.

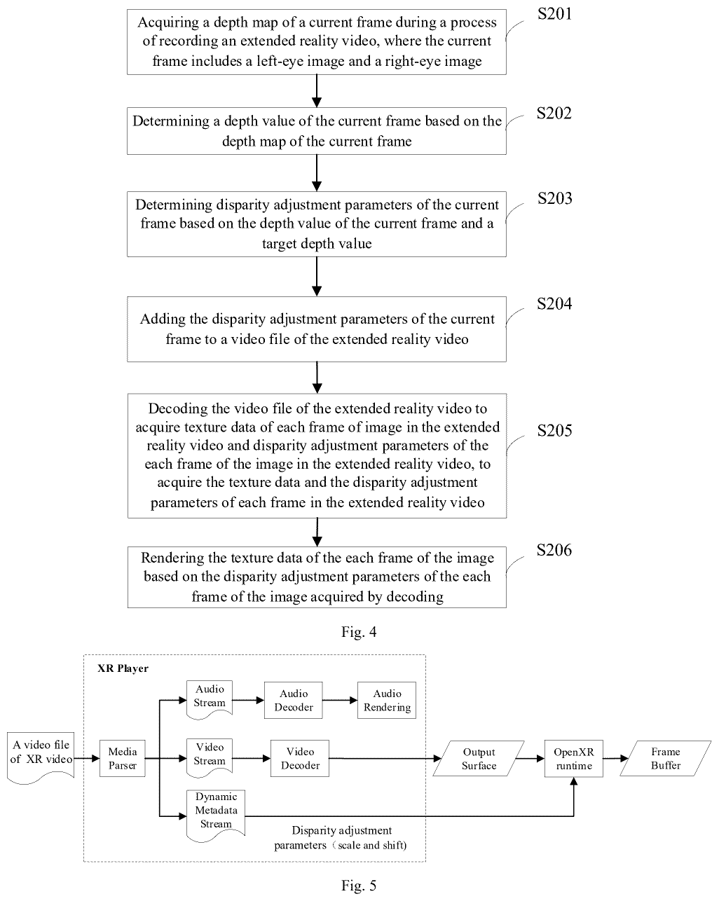

FIG. 4 is a flowchart of a disparity adjustment method for an extended reality video according to embodiment three of the present application. The method is mainly used for describing a playing flow. As shown in FIG. 4, the method provided in this embodiment includes the following steps.

S201: acquiring a depth map of a current frame during a process of recording an extended reality video, where the current frame includes a left-eye image and a right-eye image.

S202: determining a depth value of the current frame based on the depth map of the current frame.

S203: determining disparity adjustment parameters of the current frame based on the depth value of the current frame and a target depth value.

S204: adding the disparity adjustment parameters of the current frame to a video file of the extended reality video.

S201 to S204 are a recording process of the XR video. For the specific implementation, refer to the description in the foregoing embodiments. Details are not described herein again.

S205: decoding the video file of the extended reality video to acquire texture data of each frame of image in the extended reality video and disparity adjustment parameters of the each frame of the image in the extended reality video, to acquire the texture data and the disparity adjustment parameters of each frame in the extended reality video.

S206: rendering the texture data of the each frame of the image based on the disparity adjustment parameters of the each frame of the image acquired by decoding.

In the XR video playing process, step S205 and step S206 are performed. It may be understood that the playing device of the XR video may be the recording device or another XR device. After recording the XR video by using the foregoing method, the recording device may send the XR video to another XR device for playing in addition to playing the XR video by itself.

The XR video is played by an XR player on the XR device. FIG. 5 is a schematic diagram of a processing flow of an XR video by the XR player. Referring to FIG. 5, the XR player includes a media parser, a video decoder, an audio decoder, and an audio renderer.

After acquiring the video file of the XR video, the media parser parses the video file of the XR video to acquire an audio stream, a video stream, and a dynamic metadata stream. The dynamic metadata stream includes the disparity adjustment parameter.

The media parser sends the parsed video stream to the video decoder for decoding, and decoded video data acquired by decoding by the video decoder is rendered into a shared buffer (that is, output Surface) of a display system (OpenXR runtime). The media parser sends the parsed audio stream to the audio decoder for decoding, and decoded audio data is sent to the audio renderer for rendering as a final audio output.

The media parser sends the parsed dynamic metadata stream to the OpenXR runtime. The OpenXR runtime renders a decoded frame into a frame buffer (Frame Buffer, FB) of a screen based on the disparity adjustment parameters and data in the output Surface, to complete playing of the XR video.

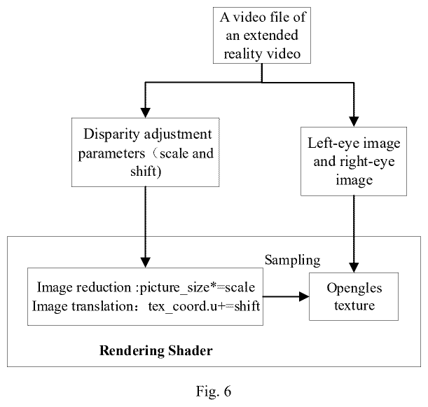

FIG. 6 is a schematic diagram of rendering by the OpenXR runtime. As shown in FIG. 6, the video player parses and decodes the video file to acquire the left-eye image and the right-eye image of each frame of image and the synchronous disparity adjustment parameters. The left-eye image and the right-eye image are used as textures and are input into a rendering shader of the OpenXR runtime. The scaling factor and the offset are used as uniform variables and are input into the rendering shader. The rendering shader scales the image by using the scaling factor (scale) and shifts the image by using the offset (shift).

The reduced size of the left-eye image and the right-eye image may be represented as: picture_size*=scale, and the shifted position of the left-eye image and the right-eye image may be represented as: tex_coord.u+=shift, where tex_coord.u represents coordinates of the textures of the left-eye image and the right-eye image.

It should be noted that when the left-eye image and the right-eye image are adjusted by using the offset, the sum of adjustment amounts of the left-eye image and the right-eye image is equal to the offset. For example, when the offset is 20, the left-eye image is shifted left by 10 pixels, and the right-eye image is shifted right by 10 pixels. When the offset is 6, the left-eye image is shifted left by 3 pixels, and the right-eye image is shifted right by 3 pixels.

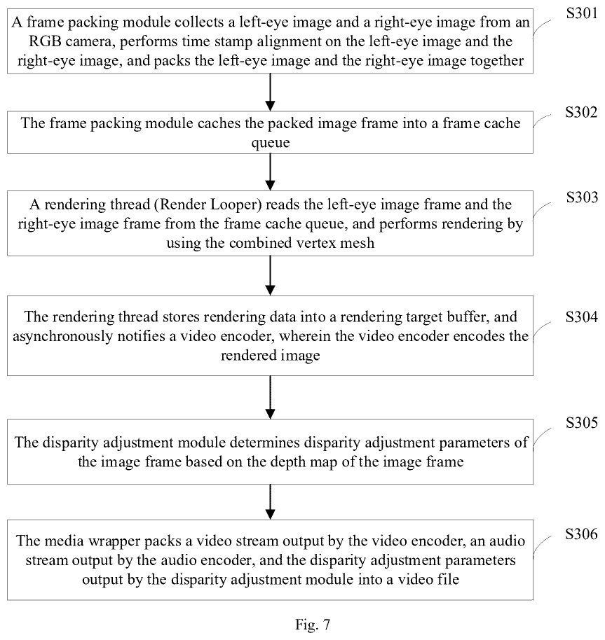

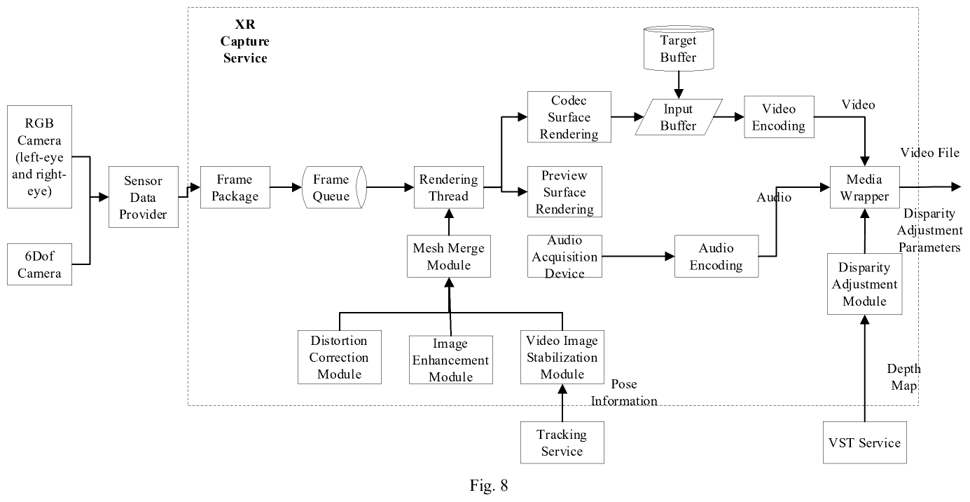

FIG. 7 is a flowchart of recording an extended reality video according to embodiment four of the present application. FIG. 8 is a schematic diagram of functional modules of an XR capture service. Referring to FIG. 7 and FIG. 8, the method provided in this embodiment includes the following steps.

S301: a frame packing module collects a left-eye image and a right-eye image from an RGB camera, performs time stamp alignment on the left-eye image and the right-eye image, and packs the left-eye image and the right-eye image together.

Referring to FIG. 8, the XR device includes an RGB camera and a 6-degree-of-freedom (Degree of freedom, Dof) camera. The RGB camera is configured to collect a left-eye RGB image and a right-eye RGB image. The 6Dof camera is configured to detect head motion data, including head rotation data and translation data. The head data collected by the 6Dof camera may be used for positioning tracking, image anti-shake processing, and the like.

The left-eye image and the right-eye image collected by the RGB camera and the motion data collected by the 6Dof camera are sent to a frame packing module (Frame Package) with a sensor data provider, and the frame packing module performs time stamp alignment on the left-eye image and the right-eye image and the motion data, and packs the left-eye image and the right-eye image and the motion data together.

S302: the frame packing module caches the packed image frame into a frame cache queue.

Due to an anti-shake algorithm requires caching 20 frames of image frames, the packed image frame needs to be cached into the frame cache queue (frame queue).

S303: a rendering thread (Render Looper) reads the left-eye image frame and the right-eye image frame from the frame cache queue, and performs rendering by using the combined vertex mesh.

Referring to FIG. 8, the XR capture service includes a video image stabilization module, an image enhancement module, a distortion correction module, and a mesh merge module. The video image stabilization module is configured to perform anti-shake processing based on device pose information provided by a tracking service. The tracking service may determine the device pose information based on the head rotation data and the translation data collected by the 6dof camera.

The image enhancement module is configured to perform enhancement processing on a video frame in terms of color, brightness, and the like. The distortion correction module is configured to perform lens distortion correction (Lens Distortion Correction, LDC) and/or stereoscopic correction (3D rectify) on the video frame. The mesh merge module is configured to merge a mesh acquired after processing by the video image stabilization module, a mesh acquired after processing by the image enhancement module, and a mesh acquired after processing by the video image stabilization module, to acquire a merged mesh. The merged mesh is sent to a rendering thread for rendering.

S304: the rendering thread stores rendering data into a rendering target buffer (buffer queue), and asynchronously notifies a video encoder, wherein the video encoder encodes the rendered image.

Referring to FIG. 8, the rendering thread performs codec surface rendering and preview surface rendering on the image frame. A rendering result of the codec surface rendering is provided to the encoder for encoding, and a rendering result of the preview surface rendering is provided to a display module for preview display.

Optionally, in this embodiment, the rendering target buffer and an input buffer (input Surface) of the video encoder share a same buffer.

S305: the disparity adjustment module determines disparity adjustment parameters of the image frame based on the depth map of the image frame.

The disparity adjustment module is configured to perform disparity adjustment on the XR video by using the disparity adjustment method provided in the embodiments of the present application. The disparity adjustment module acquires the depth map of the video frame from a video pass-through (Video Pass-Through, VST) service module.

S306: the media wrapper packs a video stream output by the video encoder, an audio stream output by the audio encoder, and the disparity adjustment parameters output by the disparity adjustment module into a video file.

Referring to FIG. 8, the XR capture service further includes an audio collection apparatus and an audio encoder. The audio collection apparatus may be a microphone of the XR device. The microphone collects audio data while the camera collects the image. The audio encoder encodes the audio data to obtain an encoded stream. The media wrapper packs the video stream output by the video encoder, the audio stream output by the audio encoder, and the disparity adjustment parameters output by the disparity adjustment module into the video file.

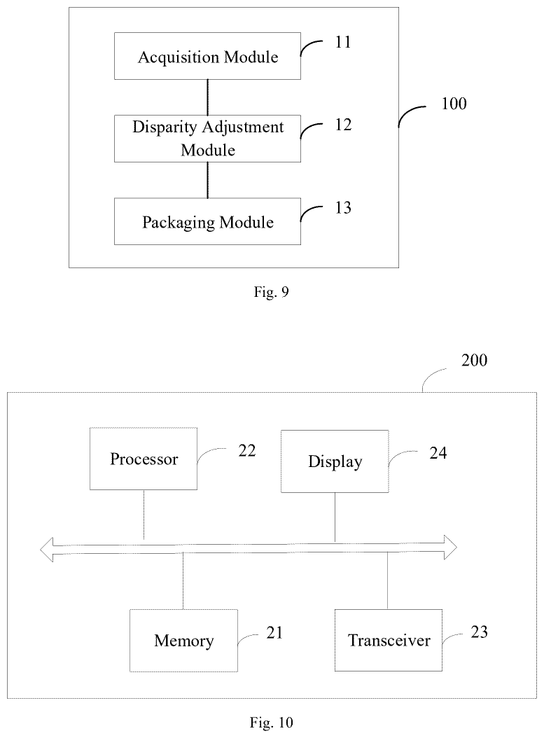

To facilitate better implementation of the disparity adjustment method for an extended reality video according to the embodiments of the present application, an embodiment of the present application further provides a disparity adjustment apparatus for an extended reality video. FIG. 9 is a schematic diagram of a structure of a disparity adjustment apparatus for an extended reality video according to embodiment five of the present application. As shown in FIG. 9, the disparity adjustment apparatus 100 for an extended reality video may include an acquisition module 11, a disparity adjustment module 12, and a packaging module 13.

The acquisition module 11 is configured to acquire a depth map of a current frame during a process of recording an extended reality video, where the current frame includes a left-eye image and a right-eye image. The disparity adjustment module 12 is configured to determine a depth value of the current frame based on the depth map of the current frame. The disparity adjustment module 12 is further configured to determine disparity adjustment parameters of the current frame based on the depth value of the current frame and a target depth value, where the disparity adjustment parameters include a scaling factor and an offset of an image, and the disparity adjustment parameters are used to adjust a disparity of the current frame to a target disparity corresponding to the target depth value. The packaging module 13 is configured to add the disparity adjustment parameters of the current frame to a video file of the extended reality video.

In some implementations, the disparity adjustment module 12 is further configured to: identify a shooting subject of the current frame; and calculating an average value of depth values of each pixel point of the shooting subject in the depth map of the current frame to acquire the depth value of the current frame.

In some implementations, the disparity adjustment module 12 is further configured to: calculate a disparity of the current frame based on the depth value of the current frame; determine disparity adjustment parameters corresponding to the depth value of the current frame based on the depth value of the current frame, the disparity of the current frame, the target depth value, and the target disparity; and determining the disparity adjustment parameters of the current frame based on the disparity adjustment parameters corresponding to the depth value of the current frame.

In some implementations, the disparity adjustment module 12 is further configured to: determine the disparity adjustment parameters corresponding to the depth value of the current frame as the disparity adjustment parameters of the current frame.

In some implementations, the disparity adjustment module 12 is further configured to: acquire, based on a preset window length, disparity adjustment parameters in a smoothing window, wherein the smoothing window includes the disparity adjustment parameters corresponding to the depth value of the current frame and disparity adjustment parameters of a plurality of frames before the current frame; and calculating an average value of disparity adjustment parameters of each frame in the smoothing window or a weighted average value of the disparity adjustment parameters of the each frame in the smoothing window to acquire the disparity adjustment parameters of the current frame.

In some implementations, the disparity adjustment module 12 is further configured to: in response to the depth value of the current frame being less than or equal to the target depth value, determine a target depth interval range to which the depth value of the current frame belongs based on the depth value of the current frame and a plurality of depth intervals, wherein different depth intervals correspond to different disparity adjustment parameter determination methods, and the plurality of depth intervals are acquired by division based on the target disparity and the target depth value; determine the disparity adjustment parameters corresponding to the depth value of the current frame based on a disparity adjustment parameters determination method corresponding to the target depth interval range; and in response to the depth value of the current frame being greater than the target depth value, determine that a scaling factor corresponding to the depth value of the current frame is 1 and an offset corresponding to the depth value of the current frame is 0.

In some implementations, the plurality of depth intervals are acquired by division as follows: determine that ½ of the target depth value is a first depth value; determine a second depth value based on the target disparity, a minimum value of the scaling factor, and a maximum value of the offset, wherein the second depth value is a minimum depth value that can be adjusted when the image is subjected to disparity adjustment by using the maximum value of the offset and the minimum value of the scaling factor, and the second depth value is less than the first depth value; and divide an image depth value into three depth intervals based on the first depth value, the second depth value, and the target depth value, wherein a first depth interval is (z1, z_target], a second depth interval is (z2, z1], and a third depth interval is (0, z2], z1 is the first depth value, z2 is the second depth value, and z_target is the target depth value.

In some implementations, the disparity adjustment module 12 is further configured to: in response to the depth value of the current frame being located in the first depth interval, determine that the scaling factor corresponding to the depth value of the current frame is a ratio of the depth value of the current frame to the target depth value, and determine that the offset corresponding to the depth value of the current frame is 0; in response to the depth value of the current frame being located in the second depth interval, determine that the scaling factor corresponding to the depth value of the current frame is the minimum value, and calculate the offset corresponding to the depth value of the current frame based on the disparity of the current frame and the target disparity; and in response to the depth value of the current frame being located in the third depth interval, determine that the scaling factor corresponding to the depth value of the current frame is the minimum value, and determine that the offset corresponding to the depth value of the current frame is the maximum value.

In some implementations, the disparity adjustment module 12 is further configured to: calculate the second depth value by using the following formula:

$$z 2 = ( scale\_min * f * b ) / ( shift\_max + d\_target )$$

where f is a baseline of a binocular camera, b is a focal length of the binocular camera, d_target is the target disparity, z2 is the second depth value, scale_min is the minimum value of the scaling factor, and shift_max is the maximum value of the offset; and
calculate the offset corresponding to the depth value of the current frame by using the following formula:

$$shift = scale\_min * d\_subject - d\_target$$

where shift is the offset corresponding to the depth value of the current frame, and d_subject is the disparity of the current frame.

In some implementations, the disparity adjustment module 12 is further configured to: calculate the disparity of the current frame based on a baseline of a binocular camera, a focal length of the binocular camera, and the depth value of the current frame.

In some implementations, the disparity adjustment module 12 is further configured to: determine determining the target disparity corresponding to the target depth value based on a baseline of the binocular camera, a focal length of the binocular camera, and the target depth value.

In some implementations, a frame rate of the disparity adjustment parameters is less than a frame rate of the extended reality video, and the frame rate of the disparity adjustment parameters are equal to a frame rate of the depth map. The disparity adjustment module 12 is further configured to:
perform linear interpolation on a frame that lacks the disparity adjustment parameters based on the frame rate of the disparity adjustment parameters and the disparity adjustment parameters of the current frame, to acquire disparity adjustment parameters of the frame that lacks the disparity adjustment parameters; and adding the disparity adjustment parameters of the current frame to the video file of the extended reality video includes: add the disparity adjustment parameters of the current frame and the disparity adjustment parameters of the frame that lacks the disparity adjustment parameters to the video file, respectively.

In some implementations, the apparatus 100 further includes a playing module, configured to decode the video file of the extended reality video to acquire the texture data of each frame of image in the extended reality video and the disparity adjustment parameters of the each frame of the image in the extended reality video; and render the texture data of the each frame of the image based on the disparity adjustment parameters of each frame of image acquired by decoding.

It should be understood that the apparatus embodiments and the method embodiments may correspond to each other, and for similar descriptions, reference may be made to the method embodiments. To avoid repetition, details are not described herein again.

The apparatus 100 according to the embodiments of the present application is described above from the perspective of functional modules with reference to the drawings. It should be understood that the functional modules may be implemented in hardware, software instructions, or a combination of hardware and software modules. Specifically, the steps in the method embodiments of the present application may be completed by using integrated logic circuits of hardware in a processor and/or software instructions. The steps of the method disclosed in the embodiments of the present application may be directly embodied as being executed and completed by a hardware decoder processor, or may be executed and completed by a combination of hardware and software modules in the decoder processor. Optionally, the software module may be located in a mature storage medium in the art, such as a random access memory, a flash memory, a read-only memory, a programmable read-only memory, an electrically erasable programmable memory, or a register. The storage medium is located in a memory. The processor reads information in the memory and completes the steps in the foregoing method embodiments in combination with the hardware thereof.

An embodiment of the present application further provides an XR device. FIG. 10 is a schematic diagram of a structure of an XR device according to embodiment six of the present application. As shown in FIG. 10, the XR device 200 may include:
a memory 21 and a processor 22, where the memory 21 is configured to store a computer program and transmit the program code to the processor 22. In other words, the processor 22 may invoke and run the computer program from the memory 21, to implement the method in the embodiments of the present application.

For example, the processor 22 may be configured to perform the foregoing method embodiments according to instructions in the computer program.

In some embodiments of the present application, the processor 22 may include, but is not limited to:
a general-purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logic device, a discrete gate or transistor logic device, a discrete hardware component, and the like.

In some embodiments of the present application, the memory 21 includes, but is not limited to:
a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM) which serves as an external cache. By way of example and not limitation, many forms of RAM may be used, such as a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synch link dynamic random-access memory (SLDRAM), and a direct rambus random-access memory (DR RAM).

In some embodiments of the present application, the computer program may be divided into one or more modules. The one or more modules are stored in the memory 21 and executed by the processor 22 to complete the method provided in the present application. The one or more modules may be a series of computer program instruction segments capable of completing specific functions. The instruction segments are used to describe the execution process of the computer program in the XR device.

As shown in FIG. 10, the XR device may further include a transceiver 23, a display screen 24, and the like. The processor 22 is electrically connected to the transceiver 23 and the display screen 24, respectively.

The processor 22 may control the transceiver 23 to communicate with another device. Specifically, the transceiver 23 may send information or data to another device, or receive information or data sent by the another device. The transceiver 23 may include a transmitter and a receiver. The transceiver 23 may further include an antenna, and the number of the antenna may be one or more.

The display screen 24 may be configured to display various virtual reality scenes, VST videos, and the like. The display screen 24 may use one or two organic light emitting diode (OLED) displays, or may alternatively use other types of display solutions, such as two smaller displays, a micro display, or a flexible display.

It may be understood that although not shown in FIG. 10, the XR device 200 may further include a camera module, a wireless fidelity (Wi-Fi) module, a positioning module, a Bluetooth module, a display, a controller, and the like, which are not described herein again.

It should be understood that components in the XR device are connected through a bus system, where the bus system includes a power bus, a control bus, and a status signal bus in addition to a data bus.

The present application further provides a computer storage medium. The computer storage medium stores a computer program, and the computer program, when executed by a computer, causes the computer to perform the methods according to the above method embodiments. Alternatively, the embodiments of the present application further provide a computer program product including instructions, and the instructions, when executed by a computer, cause the computer to perform the methods according to the above method embodiments.

The present application further provides a computer program product. The computer program product includes a computer program, and the computer program is stored in a computer-readable storage medium. The processor of the XR device reads the computer program from the computer-readable storage medium, and executes the computer program, to cause the XR device to perform the methods according to the above method embodiments. For the sake of brevity, details are not described herein again.

In the several embodiments provided in the present application, it should be understood that the disclosed system, apparatus and method may be implemented in other manners. For example, the apparatus embodiments described above are merely illustrative. For example, the division of the modules is merely logical function division, and there may be other division manners in actual implementation. For example, a plurality of modules or components may be combined or integrated into another system, or some features may be ignored or not performed. In addition, the displayed or discussed mutual coupling or direct coupling or communication connection may be implemented through some interfaces, and the indirect coupling or communication connection between the apparatuses or modules may be electrical, mechanical or other forms.

The modules described as separate components may or may not be physically separate, and the components displayed as modules may or may not be physical modules, that is, may be located in one place or may be distributed on a plurality of network elements. Some or all of the modules may be selected based on actual requirements to achieve the objectives of the solutions of the embodiments. For example, the functional modules in the embodiments of the present application may be integrated into one processing module, or each of the modules may exist alone physically, or two or more modules may be integrated into one module.

The above are merely specific implementations of the present application, but the protection scope of the present application is not limited thereto. Any person skilled in the art can easily think of changes or replacements within the technical scope disclosed in the present application, and these changes or replacements shall be covered in the protection scope of the present application. Therefore, the protection scope of the present application shall be subject to the protection scope of the claims.

1. A disparity adjustment method for an extended reality video, comprising:
acquiring a depth map of a current frame during a process of recording an extended reality video, wherein the current frame comprises a left-eye image and a right-eye image;
determining a depth value of the current frame based on the depth map of the current frame;
determining disparity adjustment parameters of the current frame based on the depth value of the current frame and a target depth value, wherein the disparity adjustment parameters comprise a scaling factor and an offset of an image, and the disparity adjustment parameters are used to adjust a disparity of the current frame to a target disparity corresponding to the target depth value; and
adding the disparity adjustment parameters of the current frame to a video file of the extended reality video.

2. The method according to claim 1, wherein determining the depth value of the current frame based on the depth map of the current frame comprises:
identifying a shooting subject of the current frame; and
calculating an average value of depth values of each pixel point of the shooting subject in the depth map of the current frame to acquire the depth value of the current frame.

3. The method according to claim 1, wherein determining the disparity adjustment parameters of the current frame based on the depth value of the current frame and the target depth value comprises:
calculating a disparity of the current frame based on the depth value of the current frame;
determining disparity adjustment parameters corresponding to the depth value of the current frame based on the depth value of the current frame, the disparity of the current frame, the target depth value, and the target disparity; and
determining the disparity adjustment parameters of the current frame based on the disparity adjustment parameters corresponding to the depth value of the current frame.

4. The method according to claim 3, wherein determining the disparity adjustment parameters of the current frame based on the disparity adjustment parameters corresponding to the depth value of the current frame comprises:
determining the disparity adjustment parameters corresponding to the depth value of the current frame as the disparity adjustment parameters of the current frame.

5. The method according to claim 3, wherein determining the disparity adjustment parameters of the current frame based on the disparity adjustment parameters corresponding to the depth value of the current frame comprises:
acquiring, based on a preset window length, disparity adjustment parameters in a smoothing window, wherein the smoothing window comprises the disparity adjustment parameters corresponding to the depth value of the current frame and disparity adjustment parameters of a plurality of frames before the current frame; and
calculating an average value of disparity adjustment parameters of each frame in the smoothing window or a weighted average value of the disparity adjustment parameters of the each frame in the smoothing window to acquire the disparity adjustment parameters of the current frame.

6. The method according to claim 3, wherein determining the disparity adjustment parameters corresponding to the depth value of the current frame based on the depth value of the current frame, the disparity of the current frame, the target depth value, and the target disparity comprises:
in response to the depth value of the current frame being less than or equal to the target depth value, determining a target depth interval range to which the depth value of the current frame belongs based on the depth value of the current frame and a plurality of depth intervals, wherein different depth intervals correspond to different disparity adjustment parameter determination methods, and the plurality of depth intervals are acquired by division based on the target disparity and the target depth value;
determining the disparity adjustment parameters corresponding to the depth value of the current frame based on a disparity adjustment parameters determination method corresponding to the target depth interval range; and
in response to the depth value of the current frame being greater than the target depth value, determining that a scaling factor corresponding to the depth value of the current frame is 1 and an offset corresponding to the depth value of the current frame is 0.

7. The method according to claim 6, wherein the plurality of depth intervals are acquired by division as follows:
determining that ½ of the target depth value is a first depth value;
determining a second depth value based on the target disparity, a minimum value of the scaling factor, and a maximum value of the offset, wherein the second depth value is a minimum depth value that can be adjusted when the image is subjected to disparity adjustment by using the maximum value of the offset and the minimum value of the scaling factor, and the second depth value is less than the first depth value; and
dividing an image depth value into three depth intervals based on the first depth value, the second depth value, and the target depth value, wherein a first depth interval is (z1, z_target], a second depth interval is (z2, z1], and a third depth interval is (0, z2], z1 is the first depth value, z2 is the second depth value, and z_target is the target depth value.

8. The method according to claim 7, wherein determining the disparity adjustment parameters corresponding to the depth value of the current frame based on the disparity adjustment parameters determination method corresponding to the target depth interval range comprises:
in response to the depth value of the current frame being located in the first depth interval, determining that the scaling factor corresponding to the depth value of the current frame is a ratio of the depth value of the current frame to the target depth value, and determining that the offset corresponding to the depth value of the current frame is 0;
in response to the depth value of the current frame being located in the second depth interval, determining that the scaling factor corresponding to the depth value of the current frame is the minimum value, and calculating the offset corresponding to the depth value of the current frame based on the disparity of the current frame and the target disparity; and
in response to the depth value of the current frame being located in the third depth interval, determining that the scaling factor corresponding to the depth value of the current frame is the minimum value, and determining that the offset corresponding to the depth value of the current frame is the maximum value.

9. The method according to claim 8, wherein determining the second depth value based on the target disparity, the minimum value of the scaling factor, and the maximum value of the offset comprises:
calculating the second depth value by using the following formula:
$$z 2 = ( scale\_min * f * b ) / ( shift\_max + d\_target )$$
wherein f is a baseline of a binocular camera, b is a focal length of the binocular camera, d_target is the target disparity, z2 is the second depth value, scale_min is the minimum value of the scaling factor, and shift_max is the maximum value of the offset; and
in response to the depth value of the current frame being located in the second depth interval, calculating the offset corresponding to the depth value of the current frame based on the disparity of the current frame and the target disparity comprises:
calculating the offset corresponding to the depth value of the current frame by using the following formula:
$$shift = scale\_min * d\_subject - d\_target$$
wherein shift is the offset corresponding to the depth value of the current frame, and d_subject is the disparity of the current frame.

10. The method according to claim 1, wherein calculating the disparity of the current frame based on the depth value of the current frame comprises:
calculating the disparity of the current frame based on a baseline of a binocular camera, a focal length of the binocular camera, and the depth value of the current frame.

11. The method according to claim 1, further comprising:
determining the target disparity corresponding to the target depth value based on a baseline of the binocular camera, a focal length of the binocular camera, and the target depth value.

12. The method according to claim 1, wherein a frame rate of the disparity adjustment parameters is less than a frame rate of the extended reality video, and the frame rate of the disparity adjustment parameters is equal to a frame rate of the depth map; and
before adding the disparity adjustment parameters of the current frame to the video file of the extended reality video, the method further comprises:
performing linear interpolation on a frame that lacks the disparity adjustment parameters based on the frame rate of the disparity adjustment parameters and the disparity adjustment parameters of the current frame, to acquire disparity adjustment parameters of the frame that lacks the disparity adjustment parameters; and
adding the disparity adjustment parameters of the current frame to the video file of the extended reality video comprises:
adding the disparity adjustment parameters of the current frame and the disparity adjustment parameters of the frame that lacks the disparity adjustment parameters to the video file, respectively.

13. The method according to claim 1, further comprising:
decoding the video file of the extended reality video to acquire texture data of each frame of image in the extended reality video and disparity adjustment parameters of the each frame of the image in the extended reality video; and
rendering the texture data of the each frame of the image based on the disparity adjustment parameters of each frame of image acquired by decoding.

14. An extended reality device, comprising:
at least a processor, and
a non-transitory memory with instructions thereon,
wherein the instructions upon execution by the processor, cause the processor to:
acquire a depth map of a current frame during a process of recording an extended reality video, wherein the current frame comprises a left-eye image and a right-eye image;
determine a depth value of the current frame based on the depth map of the current frame;
determine disparity adjustment parameters of the current frame based on the depth value of the current frame and a target depth value, wherein the disparity adjustment parameters comprise a scaling factor and an offset of an image, and the disparity adjustment parameters are used to adjust a disparity of the current frame to a target disparity corresponding to the target depth value; and
add the disparity adjustment parameters of the current frame to a video file of the extended reality video.

15. The extended reality device according to claim 14, wherein when determining the depth value of the current frame based on the depth map of the current frame, the processor is caused to:
identify a shooting subject of the current frame; and
calculate an average value of depth values of each pixel point of the shooting subject in the depth map of the current frame to acquire the depth value of the current frame.

16. The extended reality device according to claim 14, wherein when determining the disparity adjustment parameters of the current frame based on the depth value of the current frame and the target depth value, the processor is caused to:
calculate a disparity of the current frame based on the depth value of the current frame;
determine disparity adjustment parameters corresponding to the depth value of the current frame based on the depth value of the current frame, the disparity of the current frame, the target depth value, and the target disparity; and
determine the disparity adjustment parameters of the current frame based on the disparity adjustment parameters corresponding to the depth value of the current frame.

17. The extended reality device according to claim 16, wherein when determining the disparity adjustment parameters of the current frame based on the disparity adjustment parameters corresponding to the depth value of the current frame, the processor is caused to:
determine the disparity adjustment parameters corresponding to the depth value of the current frame as the disparity adjustment parameters of the current frame.

18. The extended reality device according to claim 16, wherein when determining the disparity adjustment parameters of the current frame based on the disparity adjustment parameters corresponding to the depth value of the current frame, the processor is caused to:
acquire, based on a preset window length, disparity adjustment parameters in a smoothing window, wherein the smoothing window comprises the disparity adjustment parameters corresponding to the depth value of the current frame and disparity adjustment parameters of a plurality of frames before the current frame; and
calculate an average value of disparity adjustment parameters of each frame in the smoothing window or a weighted average value of the disparity adjustment parameters of the each frame in the smoothing window to acquire the disparity adjustment parameters of the current frame.

19. A non-transitory computer-readable storage medium storing instructions that cause at least a processor to:
acquire a depth map of a current frame during a process of recording an extended reality video, wherein the current frame comprises a left-eye image and a right-eye image;
determine a depth value of the current frame based on the depth map of the current frame;
determine disparity adjustment parameters of the current frame based on the depth value of the current frame and a target depth value, wherein the disparity adjustment parameters comprise a scaling factor and an offset of an image, and the disparity adjustment parameters are used to adjust a disparity of the current frame to a target disparity corresponding to the target depth value; and
add the disparity adjustment parameters of the current frame to a video file of the extended reality video.

20. The non-transitory computer-readable storage medium according to claim 19, wherein when determining the depth value of the current frame based on the depth map of the current frame, the processor is caused to:
identify a shooting subject of the current frame; and
calculate an average value of depth values of each pixel point of the shooting subject in the depth map of the current frame to acquire the depth value of the current frame.
